(19) United States
(12) Patent Application Publication
(10) Pub. No.: US 2002/0169642 A1
(43) Pub. Date: Nov. 14, 2002

(54) Computer method for collection and delivery of insurance statutory reporting information

(76) Inventors: Larry J. Kane, Cedar Rapids, IA (US); Bruce Benson, Cedar Rapids, IA (US); Gary Wicklund, Coralville, IA (US)

Correspondence Address: SHUTTLEWORTH & INGERSOLL, P.L.C., 500 FIRSTAR BANK BUILDING, P O BOX 2107, CEDAR RAPIDS, IA, 52406, US

(21) Appl. No.: 10/057,468

(22) Filed: Jan. 25, 2002

(51) Int. Cl. G06F 17/60

(52) U.S. Cl. 705/4

(57) ABSTRACT

A comprehensive system for providing hosted service for insurance company reporting and data analysis is disclosed. Using the power of an open computer network such as the internet, the system facilitates the data entry, recording, storage, reporting, and analysis of the information that insurance companies must provide to the National Association of Insurance Commissioners (NAIC), and to the states where those companies are licensed to do business.

### BACKGROUND OF INVENTION

The present invention relates generally to using the capabilities of open networks such as the internet (World Wide Web or global computer network) for the collection, compilation, and delivery of information components on an as-needed basis. In particular, the present invention relates to a method for using the internet to identify statutory reporting data and formatting requirements from a plurality of sources and to enter, report, store, or transport such information for users including insurance companies, investors, policy holders, and analysts.

Insurance companies must, on a quarterly and annual basis, report specific information in specific formats, as required by the National Association of Insurance Commissioners (NAIC). If supplied electronically, not only must the file contents be presented in a format that conforms to specifications, but the filenames must conform to specified formats and filenames and file extension labels must conform to specified naming schemes. Further, the insurance companies must report information in specific formats on a periodic basis to the various states in which the companies do business or are licensed or registered. Because the state requirements may differ from the NAIC requirements and from state to state, it may be seen that the reporting requirements may serve as a great burden to insurance companies.

The reporting information is needed by insurance examiners and is desired in various formats or as raw data by other interested parties such as shareholders, policy holders, investors, analysts, academicians, etc. Persons of ordinary skill in the technical field of insurance industry reporting will understand the general nature and categories of insurance company data or information that is typically required by states and regulators. These persons will further understand that the specific elements of data that are requested may vary from time to time but that a system for collecting and disseminating this information may be definite and understood by person's of ordinary skill in the relevant art with only general reference to the class and type of data involved.

Traditionally, the need to report or to make such information available has been met by a combination of manual effort and computer software located at the insurance company. Examples of software used for these purposes include software available from A. M. Best and from Booke Co. Once the information was compiled or recorded under prior systems, it had to be transported to a commercial printer for physical printing of the statements, and copies would be printed, and then mailed to each state, and to NAIC. In addition, attempts would be made to mail copies to other interested parties, as the company would see fit. However, there has been and remains a need for a comprehensive report generation and management method that will allow companies to efficiently satisfy the demands of regulators and other interested parties. There is a further need for such a method that combines data compilation, filing requirement determination, data verification, and report generation with an analytical data management system as a hosted service.

### SUMMARY OF INVENTION

The system of the present invention utilizes the power of an open computer network such as the internet to facilitate the entry of insurance company data into the system from a plurality of sources and by a plurality of means (including imported or downloaded data files as well as manual entry) from distributed locations. The invention further provides for the housing of input data at a location under the control of a system administrator, such as a system home site and the servers that support such a site. Information is housed in multiple formats (for example in an input database format, a compiled report .PDF or other similar format for viewing, and in an .XML, spreadsheet, or other similar format for use in calculations, analysis, and data manipulation). The system of the present invention therefore allows for the selective control of access to the data in multiple formats.

The system further facilitates the collection and analysis of updated formatting and substantive filing requirements followed by updates to the system and notification to relevant users of changes to filing requirements. The system applies regulator-generated formulas to insure that insurance company data are internally consistent and satisfy the formulaic relationships dictated by regulatory bodies. Finally, the system of the invention creates from the data various necessary regulatory filings that may be delivered by a plurality of means (including electronic) to the appropriate destinations including regulatory bodies, commercial printers, and various other interested parties.

The present invention is practiced as a hosted service to allow users such as insurance company personnel to concentrate solely on the gathering of data associated with the preparation of filings for statutory reporting, and not the mechanics of installing, maintaining, distributing, and updating a series of software applications. With this hosted system, the completion of the filing and data analysis may be automated and centralized regardless of user location. The host depository may hold data in input database format (e.g., system's user data file), whole-document, view only format (e.g., .PDF), and full access (e.g., .XML files) creating a single source for electronic statement information. The host selectively may allow user or industry access to the different files or access to data analysis.

Once a company has finalized data entry or downloading as may be required for a regulatory filing, company personnel may indicate completion, and regulatory submission files will be created and delivered electronically via the internet to regulatory bodies and/or to commercial printers for final printing. The regulatory submission by the insurance company is therefore automated after the finalization of the regulatory submission file creation and verification process. The company's electronic .PDF statement file and .XML files can be made available via the internet to interested parties, i.e., banks, shareholders, educational facilities, etc. The list of interested parties may be managed by the system with user input and through login and password protection. Notification may be delivered to the interested parties by email after the regulatory submission files and other selectively accessible data are made available. A table of e-mail addresses and passwords, maintained by the insurance company and/or by the system, is utilized to facilitate this function.

A component of the present invention is a state checklist auditor to expedite and manage the tracking of state reporting requirements. Knowing exactly what needs to be filed for each state in order to meet compliance requirements can be a time consuming task for insurance companies that operate in numerous states, or for a service provider who monitors such requirements for an insurance company. Various websites, including the NAIC web site, contain links to state checklists that identify the filing requirements for a reporting entity (for both domestic and foreign licensed entities) with the states and NAIC. These checklists are prepared by the state insurance departments and cover details on content, dates, formats and number of copies required for annual and quarterly filings. The checklists are updated by the state departments periodically and sporadically, but generally changes occur most frequently starting in December and continuing as late as April.

The state checklist auditor function of the present invention maintains an up-to-date list of stored state checklists that have been prepared by the state insurance departments. The system queries relevant state web sites on a periodic basis to identify current insurance filing checklists maintained at those sites. A periodic and automated comparison by the system for changes between the current, posted state requirements and the stored checklist allows identification and flagging of checklist files that include a change. A follow-up manual inspection of flagged files allows the system administrator to determine whether the change to the file is substantive (i.e., a change that impacts filing requirements, dates, etc.) or if the change is merely an artifact of computer processing or non-substantive file contents.

In this manner the efficiency within the system is achieved because manual labor required by the system administrator and by the insurance companies is minimized (only files shown to be altered are manually reviewed). In addition, the user is relieved of the burden of periodically monitoring the various states' checklists. The system administrator can push electronic communications to users affected by any substantive change. A stored user profile that associates users with states where the users do business allows the system administrator to notify only affected users. Preferably, the notice includes a link to the new document, i.e. the substantively altered state checklist, so that the user can fulfill its own duty to stay abreast of filing requirement changes. In addition, the manual inspection following automated identification of a change allows a system administrator to determine if changes are required within the system software (updating formats of output regulatory filings, altering queries to users to obtain newly required data, or eliminating obsolete queries and data requests).

As already described, the system of the present invention provides the capability of creating from a database of user-supplied data (downloaded data or manually inputted data typically received in response to system generated queries to the user or tables for users to complete) the standard regulatory filings, as well as .XML documents usable by interested parties and/or used by the reporting and analysis component of the present system. The reporting and analysis feature of the present invention reads the .XML-formatted documents produced by the system and creates various and sundry analytical reports and graphs, designed specifically for the insurance industry. The selective control of access to the .PDF files and the .XML files allows, for example, free access by registered interested parties to the .PDF versions of regulatory filings whereas, for example, fee-based access by registered interested parties may be allowed with the .XML files and analytical reports. The creation of the .XML files allows greater searching capability than is available through standard regulatory filing formats or image capture, .PDF type files.

### BRIEF DESCRIPTION OF DRAWINGS

FIG. 1 is a block diagram that illustrates the related parties and sites associated with the present invention.

FIG. 2 is a flow diagram that illustrates the automated and manual steps associated with maintaining a current checklist of filing requirements.

FIG. 3 is a flow diagram of an interactive session between a user and the system of the invention, whereby the user is completing the statement file content, and correcting or explaining any crosscheck errors.

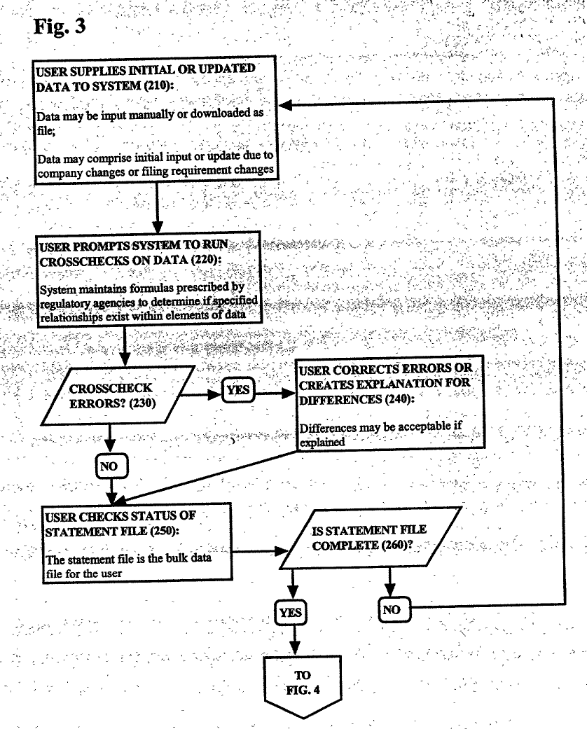

FIG. 4 is a flow diagram showing the process of interaction between the invention and a user to facilitate the completion of the filing process and the publishing of the content to appropriate parties.

### DETAILED DESCRIPTION

In its current implementation, the invention uses the Microsoft.Net development platform, the C# programming language, and the Microsoft Sequel Server relational database. Other programming languages, development platforms, and relational database platforms may be used as the specific programming necessary to carry out the present invention would be within the ordinary skill of an average programmer after having learned the method of the present invention. Such varied platform and language usage does not change the overall function of the invention.

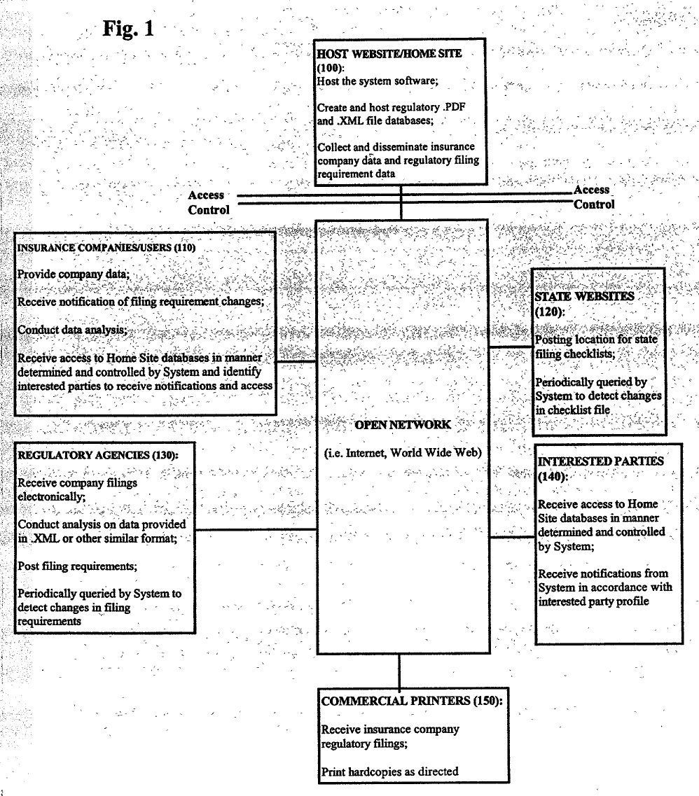

FIG. 1 is a block diagram of user, host, regulator, data source, state, and interested party relationships and information flow under the system of present invention. The home site 100 is the web site address where information maintained by the host may be accessed and stored under the system. This information includes input data files received from users, state checklists, program information for the collection of data and compilation of regulatory submission files from that data, .PDF format completed regulatory submission files, .XML data files and analytical reports, and interested party identification and password information. Users of the system (insurance companies subject to reporting requirements) 110 may first create a user profile to indicate the types of insurance carried (health, casualty, general liability, life, etc.) and the states wherein the user is authorized to conduct business and subject to reporting requirements. The user may also identify interested parties to whom the user desires data in selected formats to be made available (investors, policyholders, etc.). At least with regard to providing access to information that is contained in public, regulatory submission filings, the system administrators may identify other interested parties in addition to those parties identified by the user.

Insurance companies or authorized users 110 depict one or several users at an insurance company, the primary source for the data that is coming into the invention. Insurance companies 110 will also be the primary users of the analytical components of the invention. Users at the insurance companies 110 are able to access the home site 100, regardless of their location, as long as they have internet access. The home site 100 therefore communicates with the users 110, regulators, 130, and interested parties 140 using the power of the internet or other global computer network. Communication is not limited to the exchange of information through the home site. Rather, at selected times emails may be generated automatically by the system or generated manually (depending on the purpose of the notice and its content) and pushed to relevant users as determined by user profile.

The state web sites 120 are sources of filing requirement data and possible destinations for state level filings, depending on the capabilities of the receiving state. The state websites 120 each house information, including information in the form of a filing checklist, regarding filing requirements for the respective states. The invention periodically queries each of these state sites 120 to determine if changes have occurred in any of the filing requirements. When the invention detects changes, manual inspection of altered files is triggered to determine future need for notice and system modifications. The system may automatically notify users of any change, delay notice until manual review allows determination of the need for and appropriate content for notice, or a combination of both.

Regulatory agencies 130, such as NAIC provide an additional source of filing requirements and report destinations. Regulatory agencies 130 must be given copies of the filings, either electronic or printed, when completed by the users 110. The primary regulatory body is NAIC. At least a selected portion of the files that comprise output generated by the system of the present invention are designed to meet the filing requirements of the NAIC 130. When the user 110 has completed the entry and cross-checking of data under the system, the user may trigger the system to automatically generate and release the requisite regulatory submission files to satisfy the requirements of NAIC by pushing the necessary regulatory submission files to the regulatory site 130.

Interested parties 140 are people and organizations who have a particular interest and/or need to see the regulatory filings of a particular insurance company. A table of interested parties is maintained and associated with each insurance company. The table preferably contains passwords and electronic contact information such as e-mail addresses. When the filings are available through the web, the invention sends e-mail notifications to the interested parties. The invention will then grant the interested parties access to the regulatory submission files after the interested party passes security. Interested parties 140 may be identified by the user (mandatory for access to non-public information) or identified by self-identification through the system (such as through a request or application for information). Interested parties 140 will be registered with a profile that defines a degree of access selected by the system. For example, selected interested parties 40 may not be allowed access to .XML data and analytical reports that may be reserved for users or authorized and paying interested parties whereas regulatory submission files (e.g. “.s files”, “.v files”, etc. and PDF files that are publicly available documents after submission) may be posted in a more widely available format on the home site.

Finally, commercial printers 150 may still be an integral part of the user's data reporting structure especially if relevant states or valued interested parties continue to rely on or desire printed reports. The commercial printers 150 generate the hard copy print version of the regulatory submission files on behalf of specific insurance company users. When prompted, the system of the present invention may download the appropriate regulatory submission files to the commercial printers' web sites 150 from where the commercial printer 150 can print hard copy from the regulatory files.

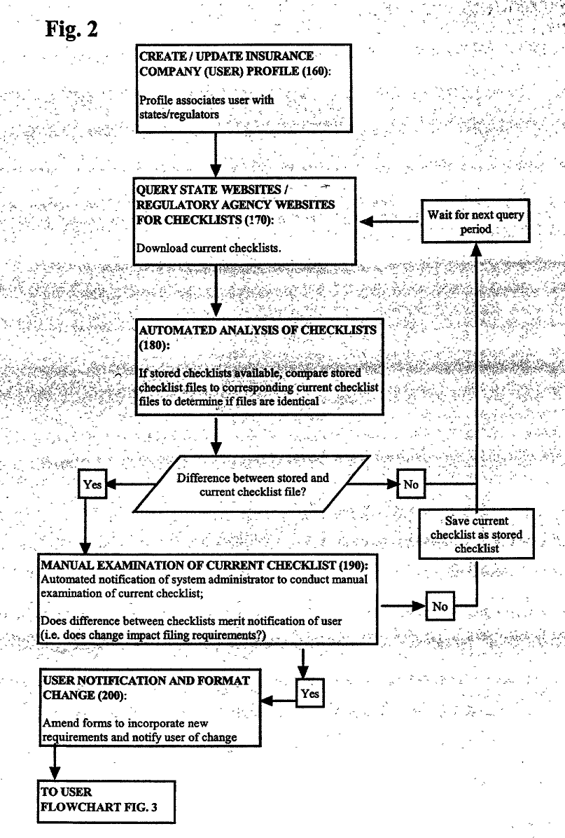

FIG. 2 illustrates the state checklist auditor function included in a preferred embodiment of the present invention. After a user has created a user profile 160 the system is able to discriminate between users to select state-specific information appropriate for the users. The user profiles are relevant not only to determine where to submit necessary regulatory filings, but also to determine which users need to receive selected notices. The system downloads state filing checklists 170 from states that make such checklists available. These downloaded checklists are stored temporarily as “current checklists” for each such state. If no prior, or “stored”, checklist is available within the system for a selected state, then the current checklist is designated and saved as the stored checklist for that state. If a prior, “stored” checklist is available for a state, the system performs an automatic comparison 180 of the stored and current checklist for the state to determine if the current checklist differs from the stored checklist. This auditing function includes review of instruction files and other files as may from time to time be deemed necessary and appropriate for periodic review.

At stages 170 and 180, the invention is periodically executing. At stage 190, the invention has found changes to one or more tables, and a system administrator is prompted to review those files to determine the nature of the identified changes. From that research, the system administrator may construct an e-mail notification, based on insurance company registration profiles, the invention will push notifications to the appropriate insurance companies 200. System software changes may be necessary. The system administrator, upon manual review, may cause the system to be modified, for example, to amend queries to seek the relevant, necessary information, to amend the output file formats and contents based on updated information, or to accommodate logistical changes dictated by the state bodies (addresses, etc.).

At stage 210, the user interacts with the user's e-mail system. The user provides initial data or additional data as indicated by the notification. Once the system data file for a user is complete, the user may interact with the invention by causing the invention to run the crosschecks 220. Crosschecks 220 are formulas supplied by the regulatory bodies that dictate numerous mathematical relationships which should exist within the various components of the data provided by the user. When the relationships do not compute properly 240, the invention produces error indications that prompt the user to research the suspect data. In some cases, the lack of a specific formulary relationship may be acceptable. In such instances, the user must create entries in an explanation file to explain why the particular user fails to satisfy the specified relationship and why such a discrepancy is acceptable within the unique circumstances present for that user. Those discrepancies that are not acceptable must be corrected. To do this, the user researches the components of the formula provided by the system and corrects the inappropriate data. Once this process is complete, the user will return to again check the statement file for completeness 250.

The user then interacts with the invention to determine whether the system's data file for the user is complete 250. Typically the system's data file for a user is constructed using data from a number of sources, some of which will come from data files downloaded into the invention, and other data that must be manually keyed into the invention. Presently preferred data entry occurs through user response to a combination of queries to the user and blank tables presented to the user for completion.

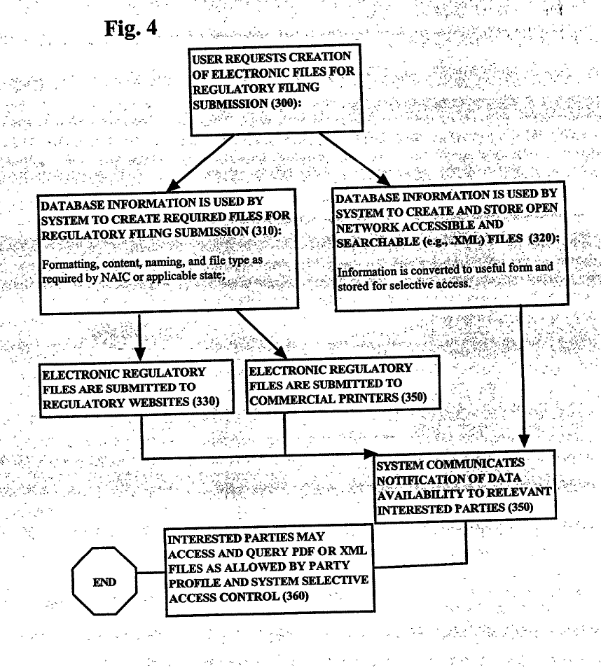

Once it is determined that the system's data file for a user is complete 260 and cross check errors are corrected or explained, the invention will proceed to FIG. 4, stage 300. If the process is not yet complete, the system will prompt the user to supply the missing information. At this stage, the user may elect a manual review to assess the completeness of the user's data file in the system.

After the system's data file for a user is complete, the user may interact with the invention 300 to prompt the automatic creation of the regulatory submission files 310 for the regulatory filing process. At stage 320, the invention creates a “value-added”, .XML file that is not required for the regulatory filing process, but that may be used for research purposes 360. The creation of such a file under the present invention combines the function of data analyst with report preparation to consolidate services for a user while eliminating the need for a user to maintain and manage the data in multiple formats.

At stage 310 the invention creates the required regulatory submission files for regulatory filing. While the regulatory bodies may, from time to time, change the exact requirements, this invention is written to accommodate those changes with minimal maintenance to the invention (i.e. programming updates vs. wholesale alteration of the system). The current implementation of the invention will create, for example, the following regulatory filing files, whose labels will be recognized by those skilled in the relevant art: (1) Specified format data files: .s data file, .e explanation file, and .v validation file; (2) .PDF whole document files including e-pages (schedules A through E), financial pages, and supplemental schedules.

At stage 330 the invention moves copies of the files created at stage 310 to the websites of the regulatory bodies, to be processed by their internal systems. At stage 340 the invention moves the files created at stage 310 to the website of the insurance company's commercial printer. The commercial printer is now prepared to print hard copies of statements, as specified by the insurance company. At stage 350, the invention pushes e-mails to interested parties to notifying them that the regulatory submission files and .XML analytical files have been published to the home site, and are available for viewing by authorized persons.

Once the users and interested parties have been made aware that the various files have been published, the users and interested parties may interact with the system through the home site to query the various .XML files, for research purposes. The invention is therefore a comprehensive data collection, report generation, requirement auditor, and data verification tool for the insurance industry that allows centralized data management for both filing and research and analysis purposes. Although .XML files are recited herein and preferred for accessibility, transferability, and uniformity, searchable analytical data files including spreadsheet files and alternative structured data files (e.g., SGML files) may be generated within the scope of the present invention.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included within the scope of the following claims.

1. A method for efficiently collecting, organizing, and disseminating insurance company data, said method comprising the steps of:
creating a user profile for an insurance company;
determining via an open computer network and from a plurality of sources a plurality of filing requirements based on said user profile, said plurality of filing requirements comprising cross-check formulae, submission format requirements, and required insurance company data;
generating a data collection template to obtain the required insurance company data;
periodically updating via said open computer network said plurality of filing requirements and said data collection template;
collecting from a plurality of sources via the open computer network and the data collection template the insurance company data;
applying the cross-check formulae to the collected insurance company data;
generating regulatory submission files based on said insurance company data;
communicating said regulatory submission files via the open computer network to a regulatory body;
generating a plurality of structured data files based on said insurance company data;
identifying interested parties; and
selectively allowing access by interested parties via the open computer network to said plurality of structured data files.

2. The method of claim 1 for efficiently collecting, organizing, and disseminating insurance company data, wherein:
the user profile for the insurance company includes identification of jurisdictions where the insurance company is subject to reporting requirements.

3. The method of claim 1 for efficiently collecting, organizing, and disseminating insurance company data, wherein:
the user profile for the insurance company includes identification of types of insurance provided by the insurance company.

4. The method of claim 1 for efficiently collecting, organizing, and disseminating insurance company data, wherein:
the open computer network is the internet.

5. The method of claim 1 for efficiently collecting, organizing, and disseminating insurance company data, wherein:
the plurality of sources from which the plurality of filing requirements are obtained comprise state insurance regulator web sites.

6. The method of claim 1 for efficiently collecting, organizing, and disseminating insurance company data, wherein:
the data collection template comprises a query-based data entry system.

7. The method of claim 1 for efficiently collecting, organizing, and disseminating insurance company data, wherein:
the data collection template comprises a fillable table for receiving data entries.

8. The method of claim 1 for efficiently collecting, organizing, and disseminating insurance company data, wherein:
the step of periodically updating via said open computer network said plurality of filing requirements and said data collection template further comprises the steps of:
obtaining from a state website and retaining as a stored checklist file a set of filing requirements;
periodically accessing via the open computer network a state web site and comparing the stored checklist file to a current checklist file then available at said state website to electronically determine if the current checklist file differs from the stored checklist file;
conducting a manual examination of the current checklist file if the electronic determination reveals a differences between the current and stored checklist files.

9. The method of claim 1 for efficiently collecting, organizing, and disseminating insurance company data, wherein:
the step of applying the cross-check formulae generates a positive or a negative indication of data compliance;
said method further comprising the step of:
querying the insurance company user to enter an explanation for non-compliance if the application of the cross-check formula to the insurance company data generates a negative indication of data compliance.

10. The method of claim 1 for efficiently collecting, organizing, and disseminating insurance company data wherein:
the plurality of structured data files comprise .XML files.

11. The method of claim 1 for efficiently collecting, organizing, and disseminating insurance company data wherein:
the plurality of structured data files comprise SGML files.

12. The method of claim 1 for efficiently collecting, organizing, and disseminating insurance company data wherein:
the step of selectively allowing access by interested parties via the open computer network to said plurality of structured data files and said regulatory submission file comprises:
charging a fee in exchange for access to the structured data files.

13. A method for efficiently collecting, organizing, and disseminating insurance company data, said method comprising the steps of:
creating a user profile for an insurance company;
determining via an open computer network and from a plurality of sources a plurality of filing requirements based on said user profile, said plurality of filing requirements comprising cross-check formulae, submission format requirements, and required insurance company data;
generating a data collection template to obtain the required insurance company data;
periodically updating via said open computer network said plurality of filing requirements and said data collection template;
collecting from a plurality of sources via the open computer network and the data collection template the insurance company data;
applying the cross-check formulae to the collected insurance company data;
generating regulatory submission files based on said insurance company data;
communicating said regulatory submission files via the open computer network to a regulatory body;
generating a plurality of searchable files based on said insurance company data;
identifying interested parties; and
selectively allowing access by interested parties via the open computer network to said plurality of searchable files.
